(19) United States
(12) Patent Application Publication
(10) Pub. No.: US 2016/0209681 A1
(43) Pub. Date: Jul. 21, 2016

(54) DEVICE ENCAPSULATION USING A DUMMY CAVITY

(71) Applicant: QUALCOMM MEMS Technologies, Inc., San Diego, CA (US)

(72) Inventors: Yu-Lung Hung, Zhunan Township (TW); Hsuan Han Wang, Toufen Township (TW); Ming-Fa Chen, New Taipei City (TW)

(21) Appl. No.: 14/599,045

(22) Filed: Jan. 16, 2015

(51) Int. Cl. G02F 1/01; B32B 7/14; B32B 17/00; B32B 37/18; B32B 37/00; B32B 37/10; B32B 37/12; G02F 1/21; B32B 38/10

(52) U.S. Cl. CPC G02F 1/0107; G02F 1/21; B32B 7/14; B32B 17/00; B32B 38/10; B32B 37/0015; B32B 37/0076; B32B 37/1018; B32B 37/1292; B32B 37/18; B32B 2255/26; B32B 2457/20; B32B 2307/40; B32B 2309/10; B32B 2309/12; B32B 2310/04; B32B 2363/00

(57) ABSTRACT

This disclosure provides devices, systems, and methods for reducing substrate warpage in a display device. In one aspect, the display device includes a device substrate and a cover substrate, where the device substrate includes one or more display elements and the cover substrate includes a device cavity extending partially through the cover substrate. At least one of the display elements may be sealed by a primary seal in contact with and between the cover substrate and the device substrate to define a device area. A dummy area outside of the device area may be defined between the primary seal and a secondary seal, where the secondary seal is also in contact with and between the cover substrate and the device substrate. The display device may further include a dummy cavity extending partially through the cover substrate in the dummy area.

### TECHNICAL FIELD

This disclosure relates to packaging of display devices, and more particularly to adding a dummy cavity to a cover substrate to reduce substrate warpage in packaging the display device.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of EMS device is called an interferometric modulator (IMOD). The term IMOD or interferometric light modulator refers to a device that selectively absorbs and/or reflects light using the principles of optical interference. In some implementations, an IMOD display element may include a pair of conductive plates, one or both of which may be transparent and/or reflective, wholly or in part, and capable of relative motion upon application of an appropriate electrical signal. For example, one plate may include a stationary layer deposited over, on or supported by a substrate and the other plate may include a reflective membrane separated from the stationary layer by an air gap. The position of one plate in relation to another can change the optical interference of light incident on the IMOD display element. IMOD-based display devices have a wide range of applications, and are anticipated to be used in improving existing products and creating new products, especially those with display capabilities.

Device packaging can protect the functional units of display devices, including EMS and MEMS components, from the environment. A seal around the EMS and MEMS components can enclose the display device and protect the display device from moisture and environmental contaminants as well as provide mechanical support for system components.

### SUMMARY

The systems, methods and devices of this disclosure each have several innovative aspects, no single one of which is solely responsible for the desirable attributes disclosed herein.

One innovative aspect of the subject matter described in this disclosure can be implemented in a display device. The display device includes a device substrate, one or more display elements disposed on the device substrate, a cover substrate opposite the device substrate, a primary seal between the device substrate and the cover substrate, and a secondary seal between the device substrate and the cover substrate. The primary seal provides a seal for at least one of the display elements and encloses a device area of the display device. The secondary seal and the primary seal define a dummy area outside of the device area of the display device, where the cover substrate includes a device cavity extending partially through the cover substrate in the device area and a dummy cavity extending partially through the cover substrate in the dummy area.

In some implementations, the pressure inside the dummy area and the device area is less than about 1 atmosphere. In some implementations, a depth of the device cavity and the dummy cavity is equal to half or less than half of the thickness of the cover substrate. In some implementations, the display device is laminated. In some implementations, the dummy area surrounds a perimeter of the device area. In some implementations, the dummy cavity in the dummy area is discontinuous around the perimeter of the device area. In some implementations, the cover substrate includes a plurality of cavities arranged in an array, where at least one of the cavities includes the device cavity and at least another one of the cavities includes the dummy cavity. In some implementations, each of the primary seal and the secondary seal includes an epoxy-based adhesive.

Another innovative aspect of the subject matter described in this disclosure can be implemented in a display device. The display device includes a device substrate, means for displaying an image in the display device disposed on the device substrate, a cover substrate opposite the device substrate, first means for sealing the display device provided between the device substrate and the cover substrate, and second means for sealing the display device provided between the device substrate and the cover substrate. The first sealing means encloses the displaying means in a device area of the display device. The second sealing means and the first sealing means define a dummy area outside of the device area of the display device, where the cover substrate includes a device cavity extending partially through the cover substrate in the device area and a dummy cavity extending partially through the cover substrate in the dummy area.

In some implementations, the pressure inside the dummy area and the device area is less than about 1 atmosphere. In some implementations, a depth of the device cavity is between about 100 μm and about 400 μm, and a depth of the dummy cavity is between about 100 μm and about 400 μm. In some implementations, the display device is laminated.

Another innovative aspect of the subject matter described in this disclosure can be implemented in a method of manufacturing a display device. The method includes providing a device substrate with one or more display elements formed thereon, providing a cover substrate opposite the device substrate, forming a first seal around at least one of the display elements and enclosing a device area of the display device, and forming a second seal around a dummy area outside of the device area and defined between the second seal and the first seal. The first seal is between the device substrate and the cover substrate. The second seal is between the device substrate and the cover substrate, where the cover substrate includes a device cavity extending partially through the cover substrate in the device area and a dummy cavity extending partially through the cover substrate in the dummy area.

In some implementations, the method further includes etching the cover substrate before providing the cover substrate opposite the device substrate to form the device cavity and the dummy cavity simultaneously in the cover substrate. In some implementations, the method further includes laminating the display device to reduce a size of a gap between the device substrate and the cover substrate. In some implementations, a pressure inside the dummy area and a pressure inside the device area is substantially similar after laminating the display device.

Details of one or more implementations of the subject matter described in this disclosure are set forth in the accompanying drawings and the description below. Although the examples provided in this disclosure are primarily described in terms of EMS and MEMS-based displays the concepts provided herein may apply to other types of displays such as liquid crystal displays, organic light-emitting diode (“OLED”) displays, and field emission displays. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is an isometric view illustration depicting two adjacent interferometric modulator (IMOD) display elements in a series or array of display elements of an IMOD display device.

FIG. 2 is a system block diagram illustrating an electronic device incorporating an IMOD-based display including a three element by three element array of IMOD display elements.

FIG. 3 is a flow diagram illustrating a manufacturing process for an IMOD display or display element.

FIGS. 4A-4E are cross-sectional illustrations of various stages in a process of making an IMOD display or display element.

FIGS. 5A and 5B are schematic exploded partial perspective views of a portion of an electromechanical systems (EMS) package including an array of EMS elements and a backplate.

FIG. 6A shows a cross-sectional view of an example display device including a cover substrate with a device cavity before lamination.

FIG. 6B shows a cross-sectional view of the example display device of FIG. 6A after lamination.

FIG. 6C shows a cross-sectional view of an example display device illustrating the effects of substrate warpage for a cover substrate with a device cavity.

FIG. 7A shows a cross-sectional view of an example display device including a cover substrate with a device cavity and a dummy cavity before lamination.

FIG. 7B shows a cross-sectional view of the example display device in FIG. 7A after lamination.

FIG. 7C shows a cross-sectional view of an example display device illustrating the effects of substrate warpage for a cover substrate with a device cavity and a dummy cavity.

FIG. 8 shows a top view of an example display device with a plurality of device cavities and dummy cavities.

FIG. 9 shows a top view of an example display device with a primary seal and a secondary seal.

FIG. 10 shows a flow diagram illustrating an example process for manufacturing a display device.

FIGS. 11A and 11B are system block diagrams illustrating a display device that includes a plurality of IMOD display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Implementations described herein relate to a display device such as a MEMS display device. A display device can be packaged to have two substrates coupled or otherwise attached to one another. One or both of the substrates can be transparent to display an image. A display device can include two substrates, a device substrate having one or more display elements disposed thereon, and a cover substrate having at least a cavity extending partially through the cover substrate. The display device can be enclosed by providing a seal in contact with and between the device substrate and the cover substrate. The cavity extending through the cover substrate can reduce the pressure inside the sealed display device. To minimize the effects of substrate warpage, an additional seal can enclose the surrounding area and a dummy cavity can be provided in that area and extending partially through the cover substrate.

When the enclosed display device is laminated or otherwise pressed, the height or gap in the sealed display device reduces. According to Boyle's law, the pressure in the sealed display device is inversely proportional to the volume or height of the sealed display device. Hence, the reduced height can lead to substrate warpage. However, the implementation described herein adds a dummy area and incorporates a dummy cavity in the dummy area, where the dummy area is enclosed by an additional seal outside of the sealed display device area. The addition of the dummy cavity reduces the pressure inside the dummy cavity so that display device can be more evenly pressed across the display device.

Particular implementations of the subject matter described in this disclosure can be implemented to realize one or more of the following potential advantages. The additional seal and the dummy cavity in the display device can reduce substrate warpage between the cover substrate and the device substrate. The reduced substrate warpage can increase the gap between the substrates. The increased gap between the substrates can increase touch tolerance of the display device, meaning that the display of the display device sags less and can withstand a greater amount of external force. In addition, the increased gap can further reduce particle damage because of a decreased likelihood of particles (e.g., dust, broken glass, etc.) in a smaller volume damaging the display elements and other components in the display device. The extra added cavity can also provide an improved hermetic seal, since the seal is more pressed across the display device. Moreover, the reduced substrate warpage can reduce pixel voltage, as the variation of charge across the surface of the substrate can be reduced.

An example of a suitable EMS or MEMS device or apparatus, to which the described implementations of the display device may apply, is a reflective display device. Reflective display devices can incorporate interferometric modulator (IMOD) display elements that can be implemented to selectively absorb and/or reflect light incident thereon using principles of optical interference. IMOD display elements can include a partial optical absorber, a reflector that is movable with respect to the absorber, and an optical resonant cavity defined between the absorber and the reflector. In some implementations, the reflector can be moved to two or more different positions, which can change the size of the optical resonant cavity and thereby affect the reflectance of the IMOD. The reflectance spectra of IMOD display elements can create fairly broad spectral bands that can be shifted across the visible wavelengths to generate different colors. The position of the spectral band can be adjusted by changing the thickness of the optical resonant cavity. One way of changing the optical resonant cavity is by changing the position of the reflector with respect to the absorber.

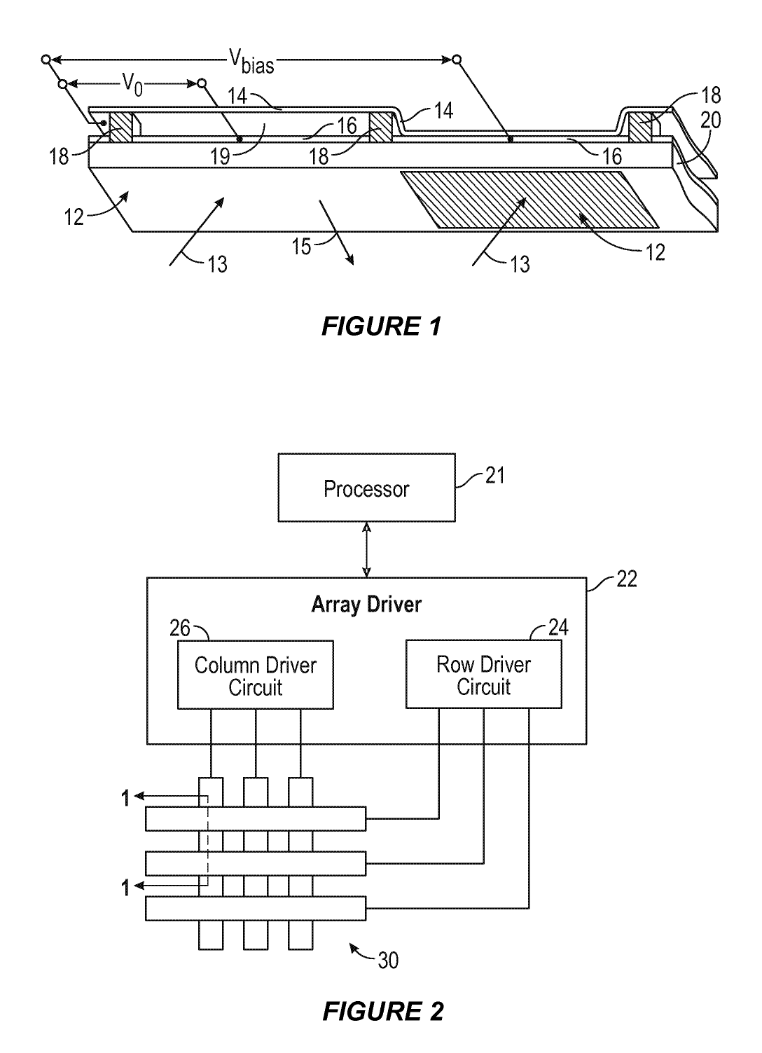

FIG. 1 is an isometric view illustration depicting two adjacent interferometric modulator (IMOD) display elements in a series or array of display elements of an IMOD display device. The IMOD display device includes one or more interferometric EMS, such as MEMS, display elements. In these devices, the interferometric MEMS display elements can be configured in either a bright or dark state. In the bright (“relaxed,” “open” or “on,” etc.) state, the display element reflects a large portion of incident visible light. Conversely, in the dark (“actuated,” “closed” or “off,” etc.) state, the display element reflects little incident visible light. MEMS display elements can be configured to reflect predominantly at particular wavelengths of light allowing for a color display in addition to black and white. In some implementations, by using multiple display elements, different intensities of color primaries and shades of gray can be achieved.

The IMOD display device can include an array of IMOD display elements which may be arranged in rows and columns. Each display element in the array can include at least a pair of reflective and semi-reflective layers, such as a movable reflective layer (i.e., a movable layer, also referred to as a mechanical layer) and a fixed partially reflective layer (i.e., a stationary layer), positioned at a variable and controllable distance from each other to form an air gap (also referred to as an optical gap, cavity or optical resonant cavity). The movable reflective layer may be moved between at least two positions. For example, in a first position, i.e., a relaxed position, the movable reflective layer can be positioned at a distance from the fixed partially reflective layer. In a second position, i.e., an actuated position, the movable reflective layer can be positioned more closely to the partially reflective layer. Incident light that reflects from the two layers can interfere constructively and/or destructively depending on the position of the movable reflective layer and the wavelength(s) of the incident light, producing either an overall reflective or non-reflective state for each display element. In some implementations, the display element may be in a reflective state when unactuated, reflecting light within the visible spectrum, and may be in a dark state when actuated, absorbing and/or destructively interfering light within the visible range. In some other implementations, however, an IMOD display element may be in a dark state when unactuated, and in a reflective state when actuated. In some implementations, the introduction of an applied voltage can drive the display elements to change states. In some other implementations, an applied charge can drive the display elements to change states.

The depicted portion of the array in FIG. 1 includes two adjacent interferometric MEMS display elements in the form of IMOD display elements 12. In the display element 12 on the right (as illustrated), the movable reflective layer 14 is illustrated in an actuated position near, adjacent or touching the optical stack 16. The voltage V_{bias} applied across the display element 12 on the right is sufficient to move and also maintain the movable reflective layer 14 in the actuated position. In the display element 12 on the left (as illustrated), a movable reflective layer 14 is illustrated in a relaxed position at a distance (which may be predetermined based on design parameters) from an optical stack 16, which includes a partially reflective layer. The voltage V₀ applied across the display element 12 on the left is insufficient to cause actuation of the movable reflective layer 14 to an actuated position such as that of the display element 12 on the right.

In FIG. 1, the reflective properties of IMOD display elements 12 are generally illustrated with arrows indicating light 13 incident upon the IMOD display elements 12, and light 15 reflecting from the display element 12 on the left. Most of the light 13 incident upon the display elements 12 may be transmitted through the transparent substrate 20, toward the optical stack 16. A portion of the light incident upon the optical stack 16 may be transmitted through the partially reflective layer of the optical stack 16, and a portion will be reflected back through the transparent substrate 20. The portion of light 13 that is transmitted through the optical stack 16 may be reflected from the movable reflective layer 14, back toward (and through) the transparent substrate 20. Interference (constructive and/or destructive) between the light reflected from the partially reflective layer of the optical stack 16 and the light reflected from the movable reflective layer 14 will determine in part the intensity of wavelength(s) of light 15 reflected from the display element 12 on the viewing or substrate side of the device. In some implementations, the transparent substrate 20 can be a glass substrate (sometimes referred to as a glass plate or panel). The glass substrate may be or include, for example, a borosilicate glass, a soda lime glass, quartz, Pyrex, or other suitable glass material. In some implementations, the glass substrate may have a thickness of 0.3, 0.5 or 0.7 millimeters, although in some implementations the glass substrate can be thicker (such as tens of millimeters) or thinner (such as less than 0.3 millimeters). In some implementations, a non-glass substrate can be used, such as a polycarbonate, acrylic, polyethylene terephthalate (PET) or polyether ether ketone (PEEK) substrate. In such an implementation, the non-glass substrate will likely have a thickness of less than 0.7 millimeters, although the substrate may be thicker depending on the design considerations. In some implementations, a non-transparent substrate, such as a metal foil or stainless steel-based substrate can be used. For example, a reverse-IMOD-based display, which includes a fixed reflective layer and a movable layer which is partially transmissive and partially reflective, may be configured to be viewed from the opposite side of a substrate as the display elements 12 of FIG. 1 and may be supported by a non-transparent substrate.

The optical stack 16 can include a single layer or several layers. The layer(s) can include one or more of an electrode layer, a partially reflective and partially transmissive layer, and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals (e.g., chromium and/or molybdenum), semiconductors, and dielectrics. The partially reflective layer can be formed of one or more layers of materials, and each of the layers can be formed of a single material or a combination of materials. In some implementations, certain portions of the optical stack 16 can include a single semi-transparent thickness of metal or semiconductor which serves as both a partial optical absorber and electrical conductor, while different, electrically more conductive layers or portions (e.g., of the optical stack 16 or of other structures of the display element) can serve to bus signals between IMOD display elements. The optical stack 16 also can include one or more insulating or dielectric layers covering one or more conductive layers or an electrically conductive/partially absorptive layer.

In some implementations, at least some of the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of supports, such as the illustrated posts 18, and an intervening sacrificial material located between the posts 18. When the sacrificial material is etched away, a defined gap 19, or optical cavity, can be formed between the movable reflective layer 14 and the optical stack 16. In some implementations, the spacing between posts 18 may be approximately 1-1000 μm, while the gap 19 may be approximately less than 10,000 Angstroms (Å).

In some implementations, each IMOD display element, whether in the actuated or relaxed state, can be considered as a capacitor formed by the fixed and moving reflective layers. When no voltage is applied, the movable reflective layer 14 remains in a mechanically relaxed state, as illustrated by the display element 12 on the left in FIG. 1, with the gap 19 between the movable reflective layer 14 and optical stack 16. However, when a potential difference, i.e., a voltage, is applied to at least one of a selected row and column, the capacitor formed at the intersection of the row and column electrodes at the corresponding display element becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated display element 12 on the right in FIG. 1. The behavior can be the same regardless of the polarity of the applied potential difference. Though a series of display elements in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. In some implementations, the rows may be referred to as “common” lines and the columns may be referred to as “segment” lines, or vice versa. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 is a system block diagram illustrating an electronic device incorporating an IMOD-based display including a three element by three element array of IMOD display elements. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, for example a display array or panel 30. The cross section of the IMOD display device illustrated in FIG. 1 is shown by the lines 1-1 in FIG. 2. Although FIG. 2 illustrates a 3×3 array of IMOD display elements for the sake of clarity, the display array 30 may contain a very large number of IMOD display elements, and may have a different number of IMOD display elements in rows than in columns, and vice versa.

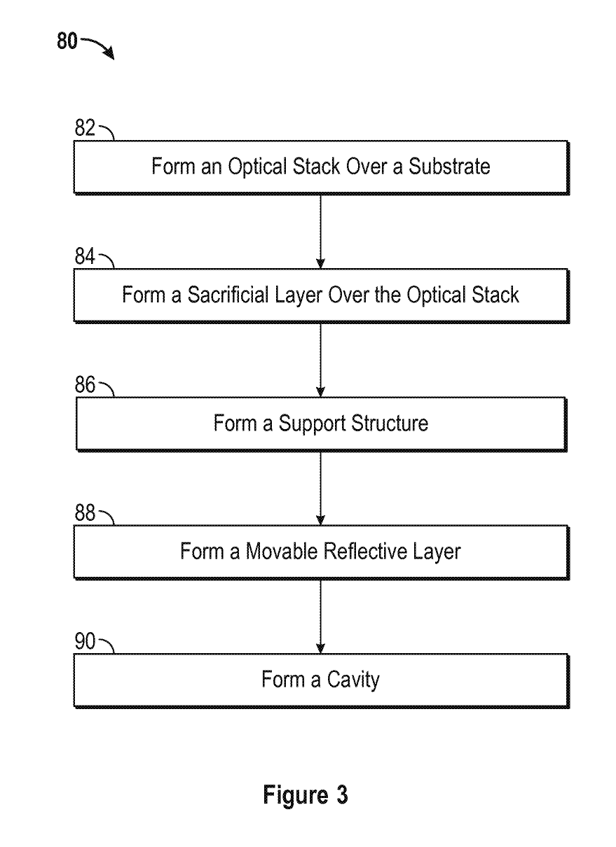

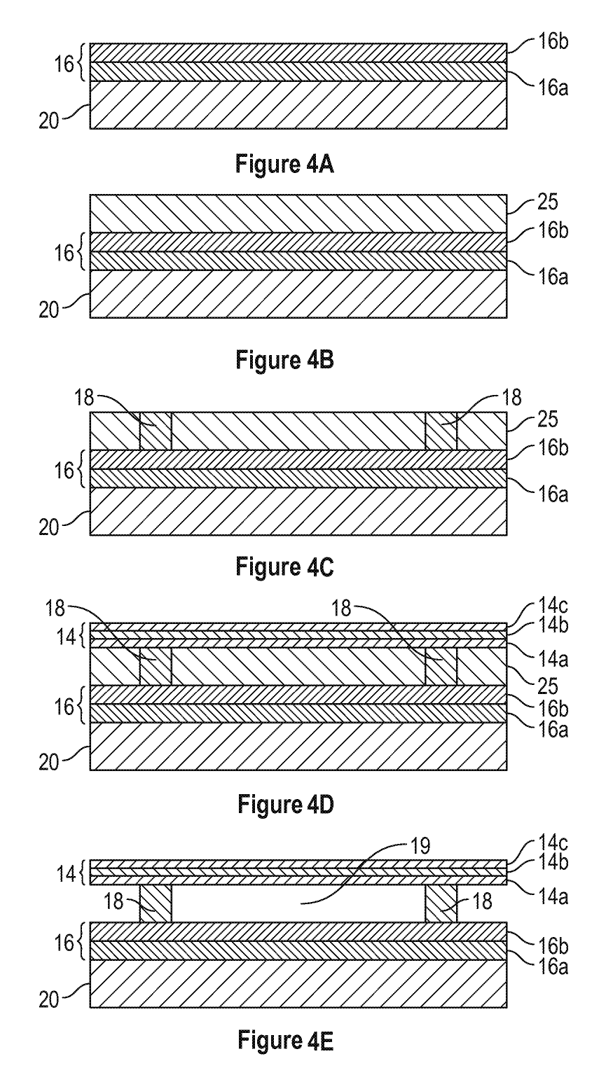

FIG. 3 is a flow diagram illustrating a manufacturing process 80 for an IMOD display or display element. FIGS. 4A-4E are cross-sectional illustrations of various stages in the manufacturing process 80 for making an IMOD display or display element. In some implementations, the manufacturing process 80 can be implemented to manufacture one or more EMS devices, such as IMOD displays or display elements. The manufacture of such an EMS device also can include other blocks not shown in FIG. 3. The process 80 begins at block 82 with the formation of the optical stack 16 over the substrate 20. FIG. 4A illustrates such an optical stack 16 formed over the substrate 20. The substrate 20 may be a transparent substrate such as glass or plastic such as the materials discussed above with respect to FIG. 1. The substrate 20 may be flexible or relatively stiff and unbending, and may have been subjected to prior preparation processes, such as cleaning, to facilitate efficient formation of the optical stack 16. As discussed above, the optical stack 16 can be electrically conductive, partially transparent, partially reflective, and partially absorptive, and may be fabricated, for example, by depositing one or more layers having the desired properties onto the transparent substrate 20.

In FIG. 4A, the optical stack 16 includes a multilayer structure having sub-layers 16a and 16b, although more or fewer sub-layers may be included in some other implementations. In some implementations, one of the sub-layers 16a and 16b can be configured with both optically absorptive and electrically conductive properties, such as the combined conductor/absorber sub-layer 16a. In some implementations, one of the sub-layers 16a and 16b can include molybdenum-chromium (molychrome or MoCr), or other materials with a suitable complex refractive index. Additionally, one or more of the sub-layers 16a and 16b can be patterned into parallel strips, and may form row electrodes in a display device. Such patterning can be performed by a masking and etching process or another suitable process known in the art. In some implementations, one of the sub-layers 16a and 16b can be an insulating or dielectric layer, such as an upper sub-layer 16b that is deposited over one or more underlying metal and/or oxide layers (such as one or more reflective and/or conductive layers). In addition, the optical stack 16 can be patterned into individual and parallel strips that form the rows of the display. In some implementations, at least one of the sub-layers of the optical stack, such as the optically absorptive layer, may be quite thin (e.g., relative to other layers depicted in this disclosure), even though the sub-layers 16a and 16b are shown somewhat thick in FIGS. 4A-4E.

The process 80 continues at block 84 with the formation of a sacrificial layer 25 over the optical stack 16. Because the sacrificial layer 25 is later removed (see block 90) to form the cavity 19, the sacrificial layer 25 is not shown in the resulting IMOD display elements. FIG. 4B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (Si), in a thickness selected to provide, after subsequent removal, a gap or cavity 19 (see also FIG. 4E) having a desired design size. Deposition of the sacrificial material may be carried out using deposition techniques such as physical vapor deposition (PVD, which includes many different techniques, such as sputtering), plasma-enhanced chemical vapor deposition (PECVD), thermal chemical vapor deposition (thermal CVD), or spin-coating.

The process 80 continues at block 86 with the formation of a support structure such as a support post 18. The formation of the support post 18 may include patterning the sacrificial layer 25 to form a support structure aperture, then depositing a material (such as a polymer or an inorganic material, like silicon oxide) into the aperture to form the support post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the support post 18 contacts the substrate 20. Alternatively, as depicted in FIG. 4C, the aperture formed in the sacrificial layer 25 can extend through the sacrificial layer 25, but not through the optical stack 16. For example, FIG. 4E illustrates the lower ends of the support posts 18 in contact with an upper surface of the optical stack 16. The support post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 4C, but also can extend at least partially over a portion of the sacrificial layer 25. As noted above, the patterning of the sacrificial layer 25 and/or the support posts 18 can be performed by a masking and etching process, but also may be performed by alternative patterning methods.

The process 80 continues at block 88 with the formation of a movable reflective layer or membrane such as the movable reflective layer 14 illustrated in FIG. 44. The movable reflective layer 14 may be formed by employing one or more deposition steps, including, for example, reflective layer (such as aluminum, aluminum alloy, or other reflective materials) deposition, along with one or more patterning, masking and/or etching steps. The movable reflective layer 14 can be patterned into individual and parallel strips that form, for example, the columns of the display. The movable reflective layer 14 can be electrically conductive, and referred to as an electrically conductive layer. In some implementations, the movable reflective layer 14 may include a plurality of sub-layers 14a, 14b and 14c as shown in FIG. 4D. In some implementations, one or more of the sub-layers, such as sub-layers 14a and 14c, may include highly reflective sub-layers selected for their optical properties, and another sub-layer 14b may include a mechanical sub-layer selected for its mechanical properties. In some implementations, the mechanical sub-layer may include a dielectric material. Since the sacrificial layer 25 is still present in the partially fabricated IMOD display element formed at block 88, the movable reflective layer 14 is typically not movable at this stage. A partially fabricated IMOD display element that contains a sacrificial layer 25 also may be referred to herein as an “unreleased” IMOD.

The process 80 continues at block 90 with the formation of a cavity 19. The cavity 19 may be formed by exposing the sacrificial material 25 (deposited at block 84) to an etchant. For example, an etchable sacrificial material such as Mo or amorphous Si may be removed by dry chemical etching by exposing the sacrificial layer 25 to a gaseous or vaporous etchant, such as vapors derived from solid XeF₂ for a period of time that is effective to remove the desired amount of material. The sacrificial material is typically selectively removed relative to the structures surrounding the cavity 19. Other etching methods, such as wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD display element may be referred to herein as a “released” IMOD.

In some implementations, the packaging of an EMS component or device, such as an IMOD-based display, can include a backplate (alternatively referred to as a backplane, back glass or recessed glass) which can be configured to protect the EMS components from damage (such as from mechanical interference or potentially damaging substances). The backplate also can provide structural support for a wide range of components, including but not limited to driver circuitry, processors, memory, interconnect arrays, vapor barriers, product housing, and the like. In some implementations, the use of a backplate can facilitate integration of components and thereby reduce the volume, weight, and/or manufacturing costs of a portable electronic device.

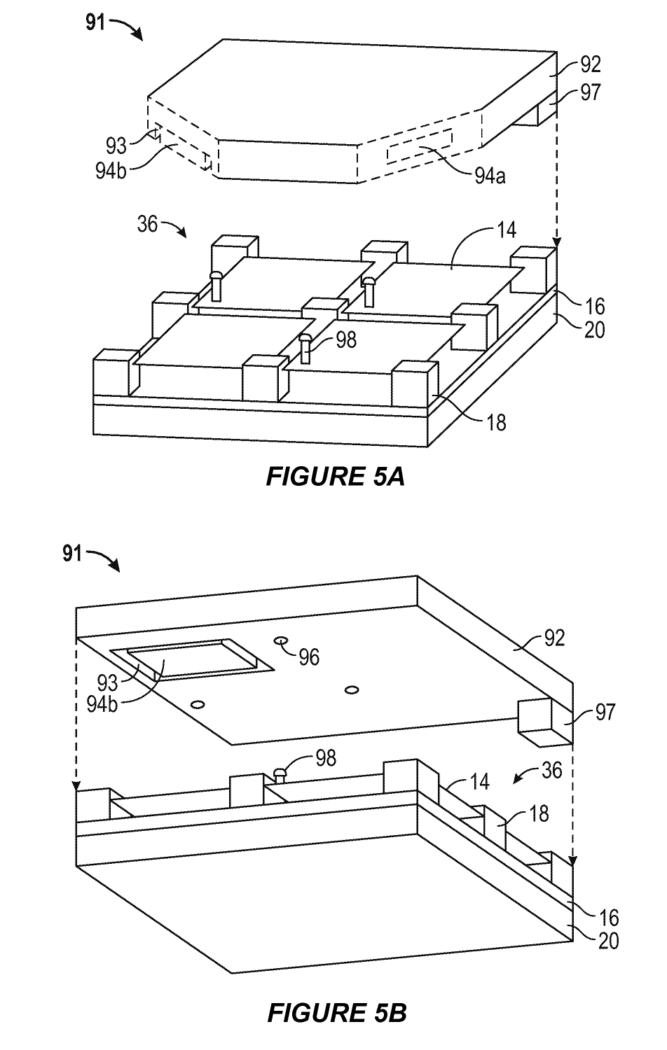

FIGS. 5A and 5B are schematic exploded partial perspective views of a portion of an EMS package 91 including an array 36 of EMS elements and a backplate 92. FIG. 5A is shown with two corners of the backplate 92 cut away to better illustrate certain portions of the backplate 92, while FIG. 5B is shown without the corners cut away. The EMS array 36 can include a substrate 20, support posts 18, and a movable layer 14. In some implementations, the EMS array 36 can include an array of IMOD display elements with one or more optical stack portions 16 on a transparent substrate, and the movable layer 14 can be implemented as a movable reflective layer.

The backplate 92 can be essentially planar or can have at least one contoured surface (e.g., the backplate 92 can be formed with recesses and/or protrusions). The backplate 92 may be made of any suitable material, whether transparent or opaque, conductive or insulating. Suitable materials for the backplate 92 include, but are not limited to, glass, plastic, ceramics, polymers, laminates, metals, metal foils, Kovar and plated Kovar.

As shown in FIGS. 5A and 5B, the backplate 92 can include one or more backplate components 94a and 94b, which can be partially or wholly embedded in the backplate 92. As can be seen in FIG. 5A, backplate component 94a is embedded in the backplate 92. As can be seen in FIGS. 5A and 5B, backplate component 94b is disposed within a recess 93 formed in a surface of the backplate 92. In some implementations, the backplate components 94a and/or 94b can protrude from a surface of the backplate 92. Although backplate component 94b is disposed on the side of the backplate 92 facing the substrate 20, in other implementations, the backplate components can be disposed on the opposite side of the backplate 92.

The backplate components 94a and/or 94b can include one or more active or passive electrical components, such as transistors, capacitors, inductors, resistors, diodes, switches, and/or integrated circuits (ICs) such as a packaged, standard or discrete IC. Other examples of backplate components that can be used in various implementations include antennas, batteries, and sensors such as electrical, touch, optical, or chemical sensors, or thin-film deposited devices.

In some implementations, the backplate components 94a and/or 94b can be in electrical communication with portions of the EMS array 36. Conductive structures such as traces, bumps, posts, or vias may be formed on one or both of the backplate 92 or the substrate 20 and may contact one another or other conductive components to form electrical connections between the EMS array 36 and the backplate components 94a and/or 94b. For example, FIG. 5B includes one or more conductive vias 96 on the backplate 92 which can be aligned with electrical contacts 98 extending upward from the movable layers 14 within the EMS array 36. In some implementations, the backplate 92 also can include one or more insulating layers that electrically insulate the backplate components 94a and/or 94b from other components of the EMS array 36. In some implementations in which the backplate 92 is formed from vapor-permeable materials, an interior surface of backplate 92 can be coated with a vapor barrier (not shown).

The backplate components 94a and 94b can include one or more desiccants which act to absorb any moisture that may enter the EMS package 91. In some implementations, a desiccant (or other moisture absorbing materials, such as a getter) may be provided separately from any other backplate components, for example as a sheet that is mounted to the backplate 92 (or in a recess formed therein) with adhesive. Alternatively, the desiccant may be integrated into the backplate 92. In some other implementations, the desiccant may be applied directly or indirectly over other backplate components, for example by spray-coating, screen printing, or any other suitable method.

In some implementations, the EMS array 36 and/or the backplate 92 can include mechanical standoffs 97 to maintain a distance between the backplate components and the display elements and thereby prevent mechanical interference between those components. In the implementation illustrated in FIGS. 5A and 5B, the mechanical standoffs 97 are formed as posts protruding from the backplate 92 in alignment with the support posts 18 of the EMS array 36. Alternatively or in addition, mechanical standoffs, such as rails or posts, can be provided along the edges of the EMS package 91.

Although not illustrated in FIGS. 5A and 5B, a seal can be provided which partially or completely encircles the EMS array 36. Together with the backplate 92 and the substrate 20, the seal can form a protective cavity enclosing the EMS array 36. The seal may be a semi-hermetic seal, such as a conventional epoxy-based adhesive. In some other implementations, the seal may be a hermetic seal, such as a thin film metal weld or a glass frit. In some other implementations, the seal may include polyisobutylene (PIB), polyurethane, liquid spin-on glass, solder, polymers, plastics, or other materials. In some implementations, a reinforced sealant can be used to form mechanical standoffs.

In alternate implementations, a seal ring may include an extension of either one or both of the backplate 92 or the substrate 20. For example, the seal ring may include a mechanical extension (not shown) of the backplate 92. In some implementations, the seal ring may include a separate member, such as an O-ring or other annular member.

In some implementations, the EMS array 36 and the backplate 92 are separately formed before being attached or coupled together. For example, the edge of the substrate 20 can be attached and sealed to the edge of the backplate 92 as discussed above. Alternatively, the EMS array 36 and the backplate 92 can be formed and joined together as the EMS package 91. In some other implementations, the EMS package 91 can be fabricated in any other suitable manner, such as by forming components of the backplate 92 over the EMS array 36 by deposition.

A display device can be packaged to withstand environmental forces and to limit the ingress of moisture and other environmental agents. When display elements are packaged in the display device, the display elements may be sealed so that the display elements are protected from ambient conditions. The seal may be a hermetic seal that substantially prevents air, water vapor, and other environmental agents from flowing through the seal, acting as a barrier between the external environment and the display device. The display device can be sealed using an epoxy-based adhesive or other suitable material. Hermeticity can be increased when the display device is more tightly pressed. For example, a volume in the display device can be sealed with a reduced volume so that a decompression force can be exerted on the display device. The display device can be laminated or otherwise pressed so that the sealant material provides a stronger hermetic seal.

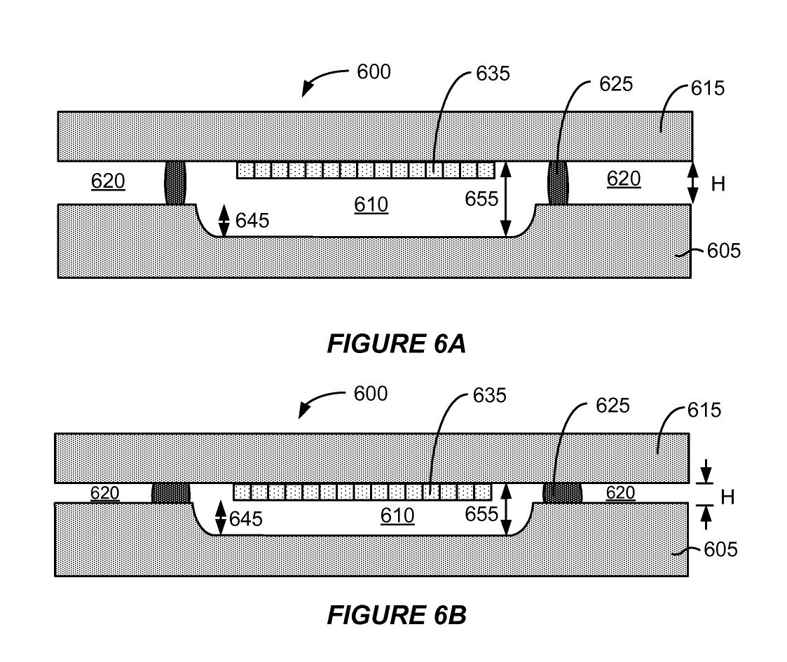

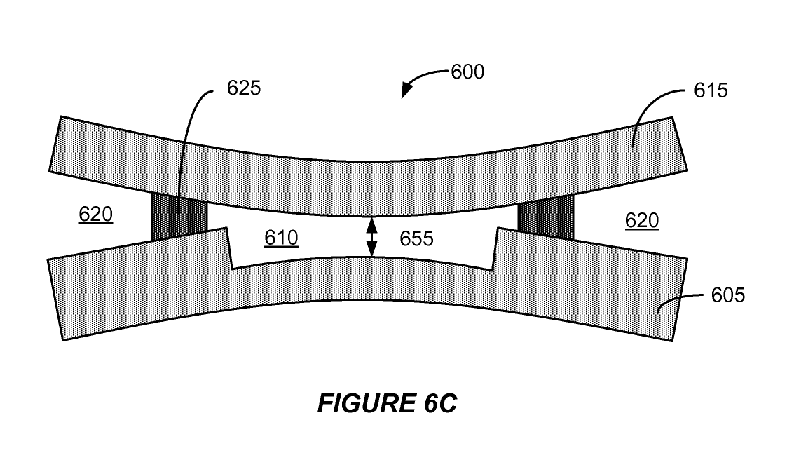

FIG. 6A shows a cross-sectional view of an example display device including a cover substrate with a device cavity before lamination. A basic structure of a display device 600 can include two substrates attached to one another by a seal 625. One of the substrates can be a device substrate 615 upon which TFTs and display elements 635 can be formed, placed, or positioned. In some implementations, the device substrate 615 can be referred to as an array substrate or a back plate. Another one of the substrates can be a cover substrate 605 provided opposite the device substrate 615. The cover substrate 605 can be recessed by having a recess or device cavity 645 extending partially through the cover substrate 605. In some implementations, the cover substrate 605 can be referred to as a recessed substrate, cover plate, cover glass, aperture plate, or transparent cover.

A seal 625 may be in contact with and between the device substrate 615 and the cover substrate 605. The seal 625 can include any suitable sealant material, such as an epoxy-based adhesive. The epoxy-based adhesive may be dispensed on the cover substrate 605 and subsequently cured. Prior to lamination, the seal 625 can have a certain height H, which can also be referred to as spacer height or gap height. For example, the height H can be between about 10 μm and about 100 μm.

The seal 625 may enclose the display elements 635 so that a sealed device area 610 is formed between the device substrate 615 and the cover substrate 605. In some implementations, the sealed device area 610 can provide an air gap 655 in which mechanical parts of the display elements 635 can move. The distance of the air gap 655 can be the distance between the device substrate 615 and the cover substrate 605, including the device cavity 645. The device cavity 645 in the sealed device area 610 can further accommodate the display elements 635. For example, the IMOD 12 in the example in FIG. 1 can be a display element with mechanical parts that can move across the air gap 655.

The display device 600 can be packaged with the seal 625 at a certain pressure inside the sealed device area 610, where the pressure can be lower than atmospheric pressure. In some implementations, the pressure can be less than about 1 atmosphere (atm) in the sealed device area 610. The reduced pressure in the sealed device area 610 can cause the device substrate 615 and the cover substrate 605 to be pulled in together. In particular, a decompression force is exerted on the display device 600 because of the difference in pressure between the inside of the display device 600 and the outside of the display device 600.

FIG. 6B shows a cross-sectional view of the example display device of FIG. 6A after lamination. The device substrate 615 and the cover substrate 605 can be tightly pressed by lamination to form a more hermetic seal. After lamination, the width of the seal 625 can be increased to provide an increased barrier for environmental agents to enter the sealed device area 610, thereby providing a more hermetic seal. Moreover, the height H of the seal 625 can be reduced and the air gap 655 between the device substrate 615 and the cover substrate 605 can be reduced. When the distance of the air gap 655 reduces, the volume of the sealed device area 610 decreases. According to Boyle's law, P1V1=P2V2, pressure is inversely proportional to the volume of the sealed device area 610. Thus, the pressure inside the sealed device area 610 increases while the pressure in a surrounding area 620 outside of the seal 625 can remain around atmospheric pressure. The increased pressure in the sealed device area 610 can lead to greater substrate warpage.

As illustrated in the example in FIGS. 6A and 6B, the cover substrate 605 can be recessed to provide a device cavity 645 for increased depth in the sealed device area 610. The device cavity 645 can alleviate the effects of an increased pressure in the sealed device area 610 resulting from lamination, thereby reducing the pressure in the sealed device area 610. However, the pressure in the surrounding area 620 of the display device 600 may still remain high. This can lead to an undesirable amount of substrate warpage, where the amount of substrate warpage can correspond to the size of the air gap 655. The increased substrate warpage can lead to reduced hermeticity. Additionally, the reduced size of the air gap 655 can reduce touch tolerance, increase the likelihood of particle damage, and increase pixel voltage.

Table 1 shows data comparing the pressure for the display device 600 in the sealed device area 610 and the surrounding area 620 before lamination and after lamination. A depth of the device cavity 645 is 300 μm, the height H of the seal 625 before lamination is 36 μm, and the subsequent height H of the seal 625 after lamination is 12 μm. The pressure can be calculated using Boyle's law. The pressure in the surrounding area 620 before lamination can be set to 0.75 atm, though it is understood that the pressure can be set to less than 0.75 atm or greater than 0.75 atm. After lamination, the pressure in the surrounding area 620 can vent to 1 atm.

TABLE 1

| | Pressure before lamination | Pressure after lamination | |
|---|---|---|---|
| Surrounding area | 0.75 atm | 1 | atm |
| Device area | 0.75 atm | 0.81 | atm |

FIG. 6C shows a cross-sectional view of an example display device illustrating the effects of substrate warpage. Under the conditions described by Table 1, the display device 600 experiences substrate warpage following lamination. The substrate warpage can be reflected by the amount of bending or deflection that a substrate undergoes relative to a flat plane. In some implementations, the amount of substrate warpage can correspond to the size of the air gap 655 between the device substrate 615 and the cover substrate 605. The size of the air gap 655 can be measured from the center of the substrates 605 and 615. As illustrated in the example in FIG. 6C, even with a cover substrate 605 having a recess or cavity, the bending that results from the conditions described in Table 1 can lead to a decreased air gap 655 and increased substrate warpage. The warpage can be caused by different air pressures, where the pressure in the device area 610 is less than the pressure in the surrounding area 620.

Substrate warpage can also lead to an increase in sealant defect, meaning that the seal 625 is not pressed effectively against the substrates 605 and 615. For example, the seal 625 can be at an uneven height with respect to the surrounding area 620 and the sealed device area 610. Referring to FIGS. 6A and 6B, if the spacer height within the display device 600 is supposed to be X (e.g., 12μm) after lamination, to the extent that height H after lamination is greater than X means that the effective width of the seal 625 is not enough. This means that there is incomplete pressing of the seal 625, resulting in leaks or a width of the seal 625 that is too narrow. Furthermore, in FIG. 6C, the side of the seal 625 facing towards the sealed device area 610 may be smaller than the side of the seal 625 facing towards the surrounding area 620. As a result, the seal 625 does not contact the substrates 605 and 615 as well near the surrounding area 620 compared to the sealed device area 610. Therefore, the seal 625 is not as strong of a hermetic seal than if the seal 625 were contacting substrates 605 and 615 with minimal substrate warpage.

A sealant defect ratio can reflect this phenomenon, where the sealant defect ratio can be measured by visual inspection of a seal enclosing a display device. The ratio can refer to the number of defects on a panel on average. One of the defects can be observed by a thin seal width, where the thin seal width can be observed when the seal height is greater than spacer height. The spacer height can define the distance between the substrates of the display device. Another one of the defects can be observed where the seal is separated to cause the edge of the seal to be abnormal. Table 2 shows data regarding the sealant defect ratio of a seal for an example display device with respect to pressure in the sealed device area. Table 2 also shows data regarding the air gap with respect to pressure in the sealed device area. The depth of the cavity in the sealed device area of the display device is 250 μm. As the pressure increases, not only does the size of the air gap increase, but the sealant defect ratio also increases. In Table 2, the seal starts losing contact with the substrates when the size of the air gap reaches 140 μm.

TABLE 2

| Decompression Pressure | Air Gap | Sealant Defect Ratio |
|---|---|---|
| −26 KPa | 115 μm | 0% |
| −23 KPa | 140 μm | 5% |
| −20 KPa | 161 μm | 15% |
| −17 KPa | 181 μm | 43% |
| −14 KPa | 201 μm | 70% |

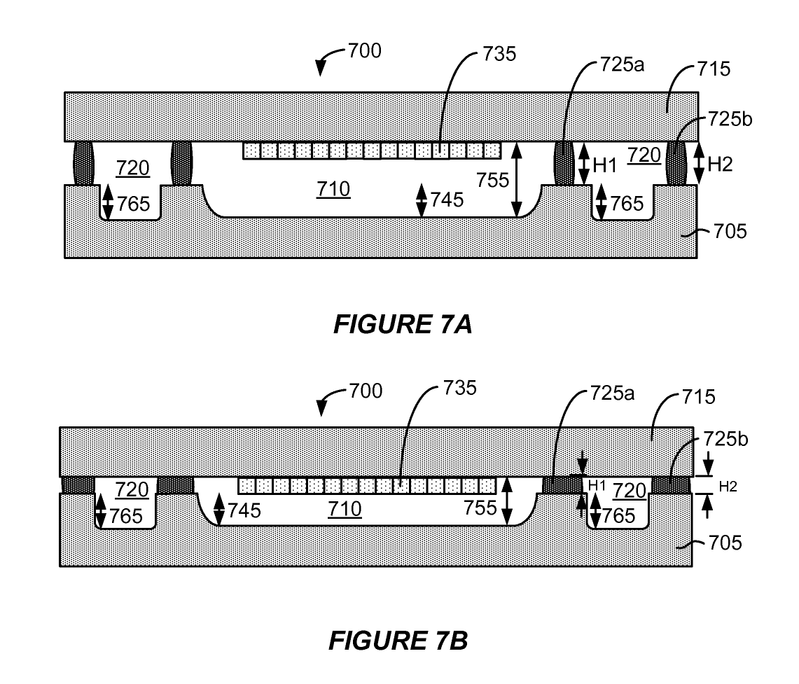

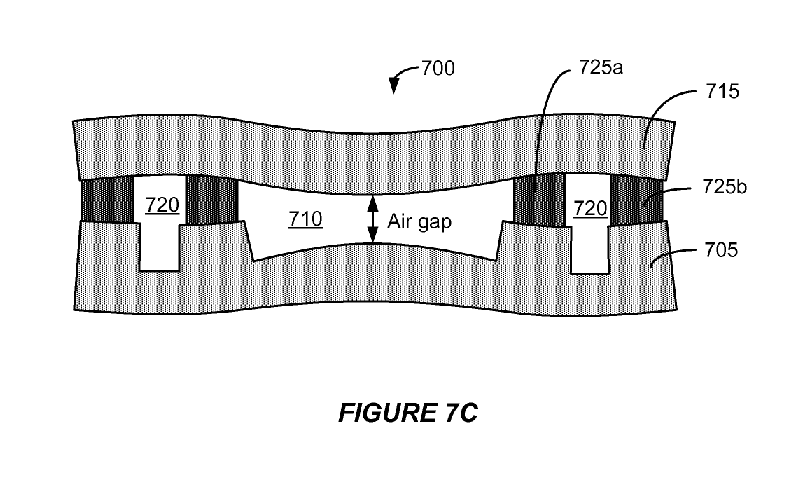

FIG. 7A shows a cross-sectional view of an example display device including a cover substrate with a device cavity and a dummy cavity before lamination. A display device 700 can have two substrates attached to one another, including a device substrate 715 opposite a cover substrate 705. The device substrate 715 may also be referred to as a an array substrate or a back plate in some implementations, upon which TFTs and one or more display elements 735 may be formed, placed, or positioned upon. The one or more display elements 735 may be arranged as an array of display elements 735, which can be referred to as pixels. In some implementations, the one or more display elements 735 can include MEMS display elements. In some implementations, the one or more display elements 735 can include OLED, IMOD, or shutter-based display elements.

The device substrate 715 can be made of any suitable substrate materials, including transparent and non-transparent materials. For example, the device substrate 715 can be a transparent substrate made of glass, plastic, or other substantially transparent material. Substantial transparency as used herein can be defined as transmittance of visible light of about 70% or more, such as about 80% or more or about 90% or more. Glass substrates (sometimes referred to as glass plates or panels) may be or include a borosilicate glass, a soda lime glass, photoglass, quartz, Pyrex or other suitable glass material. A non-glass substrate can be used, such as a polycarbonate, acrylic, polyimide, polyethylene terephthalate (PET) or polyether ether ketone (PEEK) substrate. In some implementations, the device substrate 715 can have dimensions of a few microns to hundreds of microns, such as having a thickness between about 10 μm and about 1100 μm. The thickness of the device substrate 715 can vary according to implementation.

The cover substrate 705 can be opposite the device substrate 715 and serve as a cover for the one or more display elements 735. The cover substrate 705 may also be referred to as a recessed substrate, cover plate, cover glass, aperture plate, or transparent cover in some implementations. The cover substrate 705 may provide protection for the one or more display elements 735 from external forces and ambient conditions, such as temperature, pressure, moisture, and other environmental conditions. The cover substrate 705 can also be made of any suitable substrate materials, including a substantially transparent material, such as glass or plastic. Other suitable materials can include any of the aforementioned materials described with respect to the device substrate 715.

A recess or device cavity 745 may extend partially through the cover substrate 705. In some implementations, the device cavity 745 may be formed by removing a portion of material from the cover substrate 705 using any suitable technique known in the art, such as wet etching or dry etching techniques. In some implementations, the cover substrate 705 can have a thickness between about 10 μm and about 1100 μm. The device cavity 745 can have a depth that is about half or less than half of the thickness of the cover substrate 705. For example, the device cavity 745 can have a depth that is between about 20% and about 50% of the thickness of the cover substrate 705. If the cover substrate 705 has a thickness between about 500 μm and 800 μm, then the depth of the device cavity 745 can be between about 100 μm and about 400 μm such as between about 250 μm and about 300 μm. That way, the cover substrate 705 does not become too thin and can maintain its structural rigidity and strength for protecting the display device 700.

The two substrates 705 and 715 may be attached to one another by a primary seal 725a and a secondary seal 725b disposed between the two substrates 705 and 715. The primary seal 725a may enclose at least one of the display elements 735 in the display device 700. When the primary seal 725a encloses the at least one display element 735, a device area 710 is formed between the device substrate 715 and the cover substrate 705. The device area 710 may include a gap 755 separating the device substrate 715 and the cover substrate 705. In some implementations, the gap 755 can be an air gap. The secondary seal 725b may be formed, placed, or positioned outside of the device area 710. In some implementations, the secondary seal 725b may be provided along a perimeter of the display device 700. The secondary seal 725b is not placed beyond a cutting line of the substrates 705 and 715. A surrounding area or dummy area 720 outside of the sealed device area 710 may be between the primary seal 725a and the secondary seal 725b. In some implementations, the secondary seal 725b may enclose the dummy area 720.

The display device 700 can be characterized as having a device area 710 and a surrounding area or dummy area 720. In some implementations, the placement of the primary seal 725a can define the device area 710 and the placement of the secondary seal 725b can define the dummy area 720, where the dummy area 720 can constitute the area of the display device 700 between the primary seal 725a and the secondary seal 725b. In some implementations, the dummy area 720 of the display device 700 can include a routing area from which one or more electrical components can communicate with the one or more display elements 735. For example, one or more TFTs, ICs, touch sensors, pressure sensors, gas sensors, RF switches, accelerometers, gyroscopes, microphones, speakers, or other electrical components can be formed, placed, or positioned in the dummy area 720. For example, one or more electrically conductive traces can be formed, placed, or positioned on the device substrate 715 in the dummy area 720.

The primary seal 725a and the secondary seal 725b can include any appropriate sealant material. In some implementations, each of the primary seal 725a and the secondary seal 725b can include an organic material, such as an epoxy-based adhesive. The epoxy-based adhesive can be dispensed and cured to seal the display device 700. The epoxy-based adhesive may be curable using a thermal, ultraviolet (UV), or microwave cure. An example of a suitable epoxy-based adhesive can include UV-curable XNR5570 from Nagase Chemtex Corporation in Japan. Additional examples of organic adhesives can include polyisobutylene (PIB), polyurethane, benzocyclobutylene (BCB), liquid crystal polymers, polyolefin, and other thermal plastic resins. In some implementations, one or both of the primary seal 725a and the secondary seal 725b can include an inorganic material, such as a glass frit.

In the dummy area 720 of the display device 700, a dummy cavity 765 may be formed extending partially through the cover substrate 705. The dummy cavity 765 forms a recess to enlarge the space inside the dummy area 720, thereby reducing the pressure inside the dummy area 720. The dummy cavity 765 may be formed by removing a portion of the material from the cover substrate 705. In some implementations, the depth of the dummy cavity 765 may be identical to the depth of the device cavity 745. In some implementations, the depth of the dummy cavity 765 can be different from the depth of the device cavity 745, depending on a desired pressure in each of the device area 710 and the dummy area 720. The dummy cavity 765 can have a depth that is about half or less than half of the thickness of the cover substrate 705. For example, the dummy cavity 765 can have a depth that is between about 20% and about 50% of the thickness of the cover substrate 705. If the cover substrate 705 has a thickness between about 500 μtm and 800 μm, then the depth of the dummy cavity 765 can be between about 100 μm and about 400 μm, such as between about 250 μm and about 300 μm.

Within the device area 710, a gap 755 may be defined between the device substrate 715 and the cover substrate 705. The device cavity 745 may enlarge the size of the gap 755 to further accommodate the one or more display elements 735. For example, the IMOD 12 in the example in FIG. 1 can be a display element with mechanical parts that can move across the gap 755. The IMOD 12 can include the movable reflective layer 14 that is actuated near or adjacent to optical stack 16 upon an applied voltage in one of the pixels and the movable reflective layer 14 that is unactuated from the optical stack 16 and separated by the gap 755 in another one of the pixels.

The size of the gap 755 can correspond to the amount of substrate warpage in the two substrates 705 and 715. A smaller gap size can correspond to greater substrate warpage while a larger gap size can correspond to reduced substrate warpage. Reduced substrate warpage can provide improved hermeticity, where the primary seal 725a and the secondary seal 725b can be pressed more tightly for sealing the display device 700. Reduced substrate warpage can also reduce pixel voltage by reducing variations in surface charge of the device substrate 715 from center to edge. In other words, less voltage may be required to drive the pixels with reduced substrate warpage. A larger gap size can correspond to reduced particle damage, meaning that there is a decreased likelihood of particles such as dust and broken glass damaging the one or more display elements 735 or other device components. Furthermore, a larger gap size can correspond to increased touch tolerance, meaning that more force may be required to cause the cover substrate 705 to make contact with the one or more display elements 735 or other device components. In a point load test for a sample display device, a larger air gap provided a flatter cover glass that could withstand greater press force and tension stress before stress failure compared to a more distorted cover glass having a smaller air gap.

In some implementations, the gap 755 can be an air gap. In some implementations, the gap 755 can be filled with a fluid so that the one or more display elements 735 may be immersed in the fluid. In some implementations, the fluid can have a low coefficient of friction, low viscosity, and minimal degradation effects over the long term. Examples of suitable fluids include, without limitation, de-ionized water, methanol, ethanol and other alcohols, paraffins, olefins, ethers, silicone oils, fluorinated silicone oils, or other natural or synthetic solvents or lubricants.

Prior to being laminated or otherwise pressed, the primary seal 725a can have a height H1 and the secondary seal 725b can have a height H2. In some implementations, the height H1 and the height H2 can be about equal to one another. The height H1 and H2 of the primary seal 725a and the secondary seal 725b can maintain a spacer height or gap height between the two substrates 705 and 715. In some implementations, the height H1 of the primary seal 725a can determine the spacer height between the two substrates 705 and 715. In some implementations, each of the heights H1 and H2 can be between about 10 μm and about 100 μm.

The primary seal 725a and the secondary seal 725b can be in contact with and between the substrates 705 and 715. The substrates 705 and 715 can be aligned and pressed together by a decompression force. The decompression force can provide increased adhesion and contact for the primary seal 725a and the secondary seal 725b with the substrates 705 and 715. The decompression force can result from a lower pressure inside the display device 700 than outside the display device 700. In particular, the device area 710 and the dummy area 720 can be packaged to a pressure lower than the pressure outside the display device 700. In some implementations, the pressure can be about less than 1 atm inside the device area 710 and the dummy area 720, while the pressure outside of the display device 700 can be about 1 atm. This pressure differential results in a decompression force that presses the device substrate 715 and the cover substrate 705 together. The substrates 705 and 715 may be subsequently pressed together by lamination.

FIG. 7B shows a cross-sectional view of the example display device in FIG. 7A after lamination. In order to provide a more hermetic seal, the display device 700 can be laminated or otherwise pressed together. External pressure is exerted on the substrates 705 and 715 to ensure the primary seal 725a and the secondary seal 725b are more tightly pressed against the substrates 705 and 715. The height H1 of the primary seal 725a and the height H2 of the secondary seal 725b are reduced, causing the volume inside the device area 710 and the dummy area 720 to be reduced. In accordance with Boyle's law, the reduced height/volume results in an increased pressure inside the device area 710 and the dummy area 720. Furthermore, the reduced height/volume can result in an increased width in each of the primary seal 725a and the secondary seal 725b. This in turn produces a wider barrier for a more hermetic seal.

If the display device 700 were laminated or otherwise pressed and if there were no dummy cavity 765 in the dummy area 720 of the display device 700, then the pressure inside the dummy area 720 may be higher than if there were a dummy cavity 765 in the dummy area 720. For instance, the pressure inside the dummy area 720 without a dummy cavity 765 can be greater than 1 atm and the pressure inside the device area 710 can be less than 1 atm, while the pressure outside the display device 700 can be about 1 atm. This can result in pressure differences across the substrates 705 and 715 that can lead to even greater substrate warpage. However, by adding a dummy cavity 765 in the dummy area 720 of the display device 700, the pressure inside the dummy area 720 can be reduced by increasing the volume of the dummy area 720.

Despite pressure increases in the device area 710 and the dummy area 720, the depth of the dummy cavity 765 and the depth of the device cavity 745 can be made or selected to limit the effects of substrate warpage. This can occur by selecting depths so that the pressures in the device area 710 and the dummy area 720 do not exceed atmospheric pressure. Additionally, the pressure inside the device area 710 and the dummy area 720 can be substantially similar. As a result, a decompression force can maintain a tight press across the display device 700 while limiting the effects of substrate warpage.

Table 3 shows data comparing the pressure for the display device 700 in the device area 710 and the surrounding area 720 before lamination and after lamination. The depth of the device cavity 745 is 300 μm, the height H1 of the primary seal 725a and the height H2 of the secondary seal 725b before lamination are 36 μm, and the height H1 and the height H2 after lamination are 12 μm. The pressure can be calculated using Boyle's law. The data shows that the pressure in the surrounding area and the device area are 0.81 atm, meaning that the pressures are the same and less than atmospheric pressure. This allows for a decompression force to be exerted and evenly exerted on the surrounding area and the device area.

TABLE 3

| | Pressure before lamination | Pressure after lamination |
|---|---|---|
| Surrounding area | 0.75 atm | 0.81 atm |
| Device area | 0.75 atm | 0.81 atm |

FIG. 7C shows a cross-sectional view of an example display device illustrating effects of substrate warpage for a cover substrate with a device cavity and a dummy cavity. Under the conditions described by Table 3, the display device 700 may experience limited effects of substrate warpage following lamination. Not only can a decompression force be exerted in the device area 710, but the addition of a dummy cavity 765 causes a decompression force to also be exerted in the dummy area 720. Therefore, the addition of the dummy area 720 created by the secondary seal 725b as well as the addition of the dummy cavity 765 in the dummy area 720 permits a pressing force on the display device 700 following lamination to be more evenly distributed. Accordingly, the degree of substrate warpage can be reduced compared to the substrate warpage exhibited in FIG. 6C. With reduced substrate warpage, the display device 700 with the dummy cavity 765 can increase the touch tolerance, reduce the likelihood of particle damage, improve hermeticity, and reduce the pixel voltage for driving pixels for the display device 700.

Table 4 shows data for an example display device having a device cavity and a dummy cavity, where the data reflects the sealant defect ratio of a seal relative to pressure in the device area. A sealant defect can be found where there is incomplete pressing, such that the height of the primary seal may be higher than the spacer height of the display device. Table 4 also shows data regarding the air gap relative to pressure in the device area. The depth of the device cavity in the display device is 250 μm. As the pressure increases, the size of the air gap increases. However, the sealant defect ratio does not start to exhibit a defective seal until the air gap reaches about 214 μm. As shown in Table 4, the display device can have an air gap ranging from 129 μm to 204 μm without a defective seal in some implementations, whereas the display device without a dummy cavity in Table 2 can only have an air gap ranging from 115 μm to 140 μm without a defective seal.

TABLE 4

| Decompression Pressure | Air Gap | Sealant Defect Ratio |
|---|---|---|
| −26 KPa | 129 μm | 0% |
| −20 KPa | 168 μm | 0% |
| −17 KPa | 178 μm | 0% |
| −14 KPa | 204 μm | 0% |
| −14 KPa | 200 μm | 0% |
| −11 KPa | 214 μm | 3% |
| −8 KPa | 248 μm | 20% |
| −5 KPa | 256 μm | 33% |

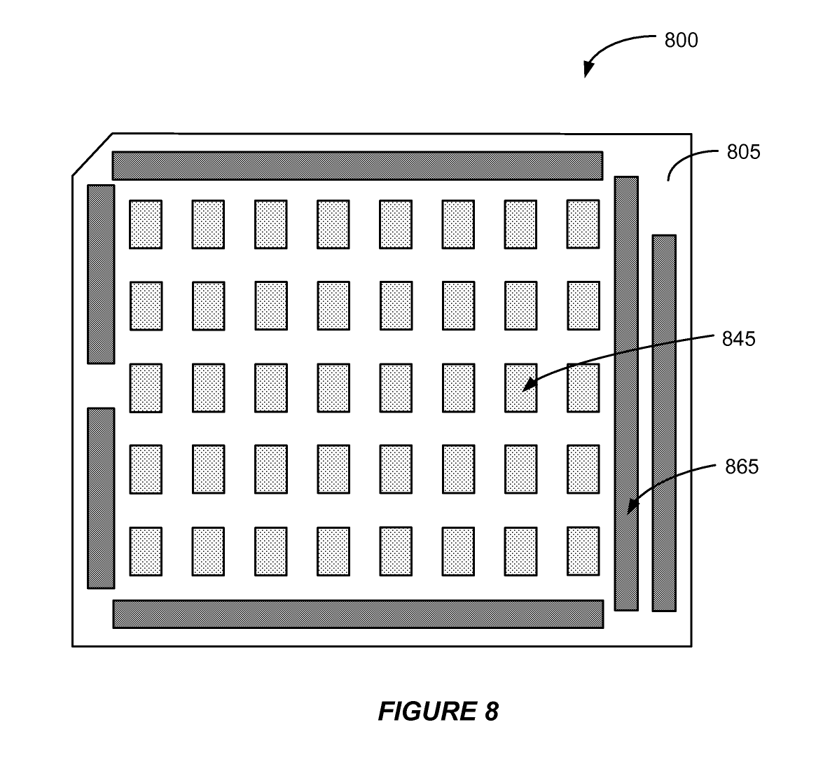

FIG. 8 shows a top view of an example display device with a plurality of device cavities and dummy cavities. In the display device 800, a plurality of display elements (not shown) may be arranged as an array of display elements, which can be referred to as pixels. Hundreds, thousands, or millions of pixels may be arranged in hundreds or thousands of rows and hundreds and thousands of columns. Each of the display elements may be driven by one or more TFTs.

A plurality of device cavities 845 may be arranged as an array in a cover substrate 805. In some implementations, the array of device cavities 845 may be aligned opposite the array of display elements. A plurality of dummy cavities 865 may be formed, place, or positioned in the cover substrate 805. The device cavities 845 may be formed, placed, or positioned in a device area of the display device 800, and the dummy cavities 865 may be formed, placed, or positioned in a dummy area outside of the device area of the display device 800. In FIG. 8A, the device area can include the array of display elements and the array of device cavities 845. In some implementations, the dummy area surrounds a perimeter of the device area. In some implementations, the dummy cavities 865 may be continuous around the perimeter of the device area. In some implementations, as illustrated in the example in FIG. 8A, the dummy cavities 865 may be discontinuous around the perimeter of the device area. Furthermore, each side of the cover substrate 805 can include a dummy cavity 865. Each of the dummy cavities 865 can have different dimensions, such as different dimensions in terms of length, width, and depth. In some implementations, one or more sides of the cover substrate 805 can include more than one dummy cavity 865.

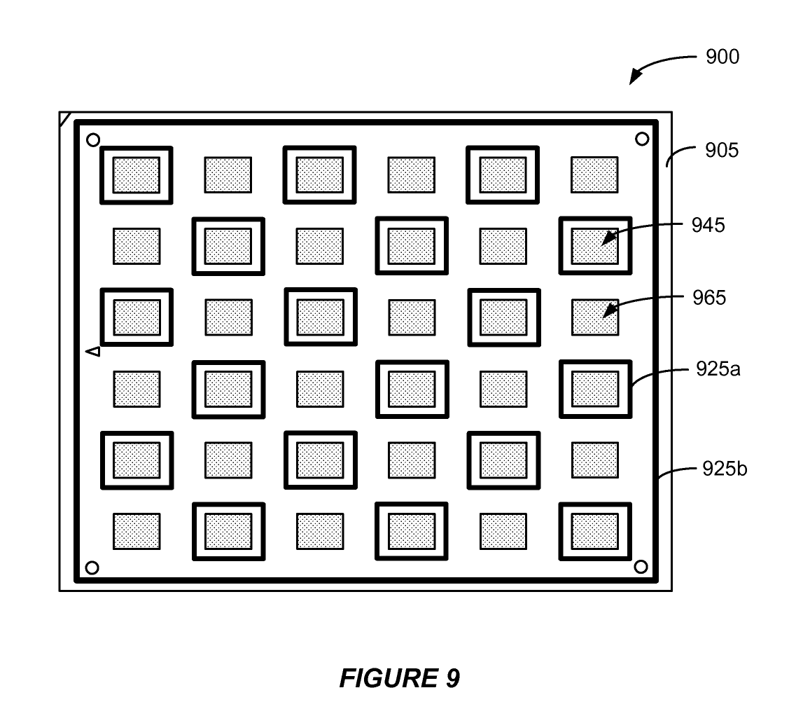

FIG. 9 shows a top view of an example display device with a primary seal and a secondary seal. The display device 900 in FIG. 9 may show a different layout of device cavities 945 and dummy cavities 965 than in the display device 800 in FIG. 8. In FIG. 9, a plurality of recesses or cavities may be arranged as an array in the cover substrate 905. Some of the cavities may be device cavities 945 and some of the cavities may be dummy cavities 965. In some implementations, the array of cavities 945 and 965 can be aligned opposite an array of display elements (not shown) in the display device 900.

A primary seal 925a may provide a seal to enclose at least one of the display elements. The primary seal 925a may be in contact with the cover substrate 905 and seal the display device 900. In FIG. 9, some of the cavities in the array are sealed by the primary seal 925a, where the cavities sealed by the primary seal 925a constitute device cavities 945. Accordingly, areas sealed by the primary seal 925 in the display device 900 can constitute a device area. The cavities that are not sealed by the primary seal 925a may constitute dummy cavities 965. A secondary seal 925b may provide a seal to enclose the display device 900. The secondary seal 925b may be in contact with the cover substrate 905 and outside of the device area. Areas outside of the device area can constitute a dummy area, where the dummy area can be defined between the primary seal 925a and the secondary seal 925b. In some implementations, the secondary seal 925b can be continuous along a perimeter of the display device 900. As illustrated in the example in FIG. 9, multiple cavities in the array can be sealed by the primary seal 925a so that multiple display elements may be sealed by the primary seal 925a. In some implementations, alternating cavities may be sealed by the primary seal 925a so as to create a “checkerboard” arrangement. Across each row and each column in the array, the cavities alternate between device cavity 945 and dummy cavity 965.

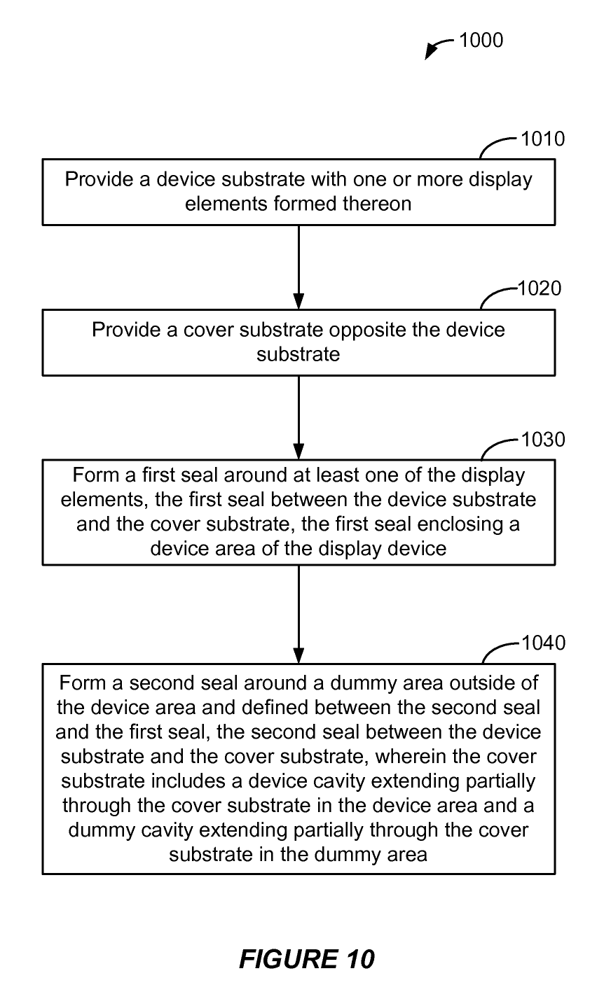

FIG. 10 shows a flow diagram illustrating an example process for manufacturing a display device. The process 900 may be performed in a different order or with different, fewer or additional operations. In some implementations, the process 900 may be described with reference to a MEMS display device.

At block 1010, a device substrate is provided with one or more display elements formed thereon. The device substrate can be made of any suitable substrate materials, including transparent or non-transparent materials. The one or more display elements can be pixels arranged in an array capable of forming an image for the display device. In some implementations, the one or more display elements can include MEMS display elements. In some implementations, the MEMS display elements can include an active matrix OLED, shutter-based light modulator, or IMOD. The display elements can be fabricated on the device substrate using one or more thin film processing steps, including deposition, masking, and/or etching steps. In some implementations, additional device elements may be formed on the device substrate, including but not limited to TFTs, ICs, touch sensors, pressure sensors, gas sensors, RF switches, accelerometers, gyroscopes, microphones, and speakers.

At block 1020, a cover substrate is provided opposite the device substrate. The cover substrate can be made of any suitable substrate materials, such as glass. In some implementations, the cover substrate can be formed of any substantially transparent material. In some implementations, the cover substrate can have a thickness between about 10 μm and about 1100 μm. The cover substrate may be provided over the one or more display elements of the device substrate. The cover substrate may be recessed such that one or more cavities may be extending partially through the cover substrate. The depth of each of the cavities may be about half or less than half of the thickness of the cover substrate. For example, the depth of each of the cavities may be between about 100 μm and about 400 μm, or between about 250 μm and about 300 μm. In some implementations, at least some of the recesses or cavities in the cover substrate may be aligned with the one or more display elements. Therefore, a larger gap may be provided from the one or more display elements to the surface of the cover substrate facing the one or more display elements.

The cover substrate may include both a device cavity and a dummy cavity. The device cavity and the dummy cavity may be formed simultaneously in the cover substrate. In some implementations, removal of portions of the cover substrate may be achieved using an etch process, such as a timed wet etch process. The cover substrate, for example, may be dipped in a solution of hydrogen fluoride (HF). The wet etch may be isotropic. In some implementations, the depth of the device cavity and the dummy cavity may be identical or substantially identical. The device cavity maybe formed in a device area and the dummy cavity may be formed in a dummy area surrounding the device area. The device area may be defined by the positioning of a first seal as described below.

At block 1030, a first seal is formed around at least one of the display elements, where the first seal is between the device substrate and the cover substrate, and the first seal encloses a device area of the display device. Where the first seal is disposed can define the device area of the display device. In some implementations, the one or more display elements can include a plurality of display elements arranged in an array, where the first seal may enclose each of the display elements in the array. In some implementations, the first seal may enclose some of the plurality of display elements in the array. Furthermore, the first seal may further enclose the device cavity of the cover substrate.

In some implementations, the first seal can include an organic material, such as an epoxy-based adhesive. In some implementations, the first seal may be dispensed and cured to seal the device area of the display device, where the first seal may be dispensed on the cover substrate.

At block 1040, a second seal is provided around a dummy area outside the device area and defined between the second seal and the first seal, the second seal being between the device substrate and the cover substrate, where the cover substrate includes a device cavity extending partially through the cover substrate in the device area and a dummy cavity extending partially through the cover substrate in the dummy area. The second seal may be disposed to define the dummy area, where the dummy area is outside of the device area. In some implementations, the second seal may be provided along a perimeter of the display device. Since the dummy cavity is in the dummy area and the dummy area is between the first seal and the second seal, the second seal can enclose the dummy cavity. Hence, what cavities in the cover substrate constitute a dummy cavity and a device cavity can be defined by the positioning of the first seal and the second seal.

In some implementations, the second seal can include an organic material, such as an epoxy-based adhesive. In some implementations, the second seal may be identical in composition and thickness as the first seal. The second seal and the first seal may be dispensed on the cover substrate and cured simultaneously.

The device area enclosed by the first seal and the dummy area enclosed by the second seal may be sealed at certain pressures prior to pressing the substrates together. The pressures may be substantially similar. The device area and the dummy area may be enclosed at a pressure less than the outside pressure of the display device. For example, the pressure inside the device area and inside the dummy area can be less than about 1 atm before lamination. By establishing a lower pressure inside the display device, a decompression force can be exerted on the display device to press the device substrate and the cover substrate together.

In some implementations, the method further includes laminating the display device to reduce a size of a gap between the device substrate and the cover substrate. Not only does the size of the gap reduce, but the height of the first seal and the second seal may be reduced. By laminating the display device, a more hermetic seal can be formed to protect the display elements and other device elements in the display device. In some implementations, the pressure inside the device area and inside the dummy area can be less than about 1 atm after laminating the display device. In some implementations, the pressure inside the device area and the pressure inside the dummy area can be substantially similar. The lamination provides a pressing force to press the display device tightly together while the dummy cavity and the device cavity can ensure that the pressure inside the display device remains less than atmospheric pressure. By maintaining a reduced pressure across the device area and the dummy area, substrate warpage can be limited and the gap between the substrates can remain sufficiently high.

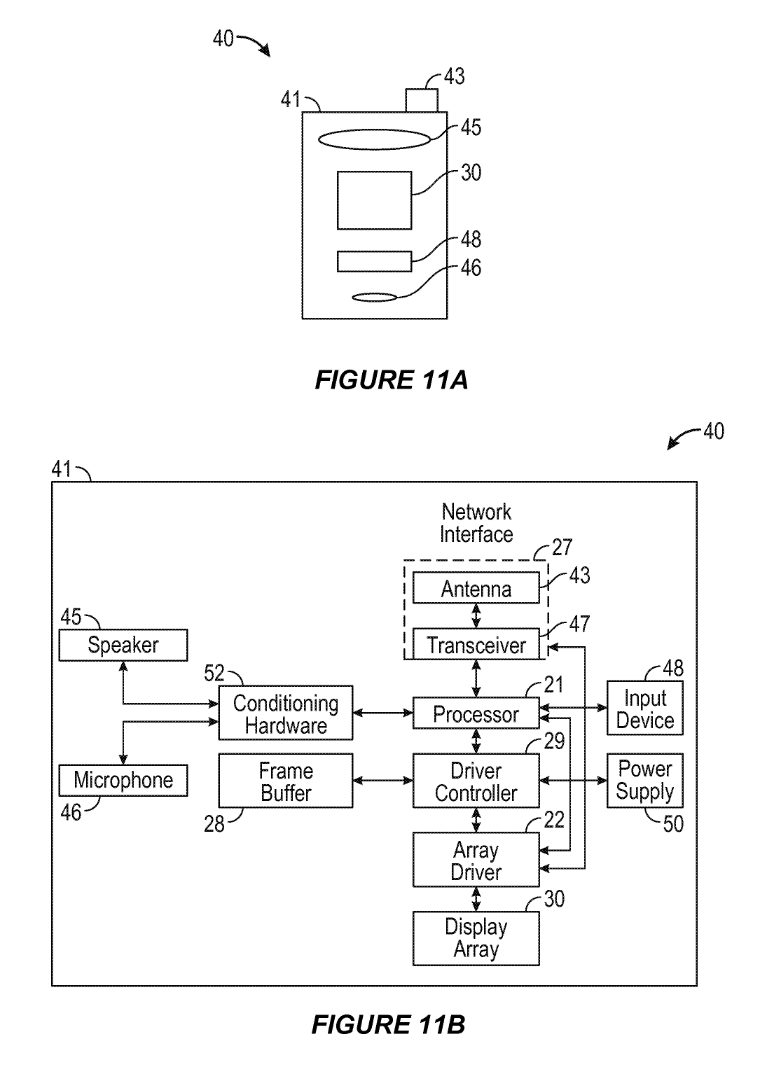

FIGS. 11A and 11B are system block diagrams illustrating a display device 40 that includes a plurality of IMOD display elements and the TFT as described herein. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an IMOD-based display, as described herein.

The components of the display device 40 are schematically illustrated in FIG. 11A. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 11A, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11 a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the driver controller 29, the array driver 22, and the display array 30 are appropriate for any of the types of displays described herein. For example, the driver controller 29 can be a conventional display controller or a bi-stable display controller (such as an IMOD display element controller). Additionally, the array driver 22 can be a conventional driver or a bi-stable display driver (such as an IMOD display element driver). Moreover, the display array 30 can be a conventional display array or a bi-stable display array (such as a display including an array of IMOD display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of, e.g., an IMOD display element as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A display device comprising:
a device substrate;
one or more display elements disposed on the device substrate;
a cover substrate opposite the device substrate;
a primary seal between the device substrate and the cover substrate, the primary seal providing a seal for at least one of the display elements, the primary seal enclosing a device area of the display device; and
a secondary seal between the device substrate and the cover substrate, the secondary seal and the primary seal defining a dummy area outside of the device area of the display device, wherein the cover substrate includes a device cavity extending partially through the cover substrate in the device area, and a dummy cavity extending partially through the cover substrate in the dummy area.

2. The device of claim 1, wherein a pressure inside the dummy area and the device area is less than about 1 atmosphere.

3. The device of claim 1, wherein a depth of the device cavity is between about 100 μm and about 400 μm, and a depth of the dummy cavity is between about 100 μm and about 400 μm.

4. The device of claim 1, wherein a depth of the device cavity and the dummy cavity is equal to half or less than half of the thickness of the cover substrate.

5. The device of claim 1, wherein a depth of the device cavity is identical to a depth of the dummy cavity through the cover substrate.

6. The device of claim 1, wherein the display device is laminated.

7. The device of claim 6, wherein a pressure inside the dummy area and a pressure inside the device area of the laminated display device is substantially similar.

8. The device of claim 1, wherein the dummy area surrounds a perimeter of the device area.

9. The device of claim 8, wherein the dummy cavity in the dummy area is discontinuous around the perimeter of the device area.

10. The device of claim 1, wherein the cover substrate includes a plurality of cavities arranged in an array, wherein at least one of the cavities includes the device cavity and at least another one of the cavities includes the dummy cavity.

11. The device of claim 1, wherein the one or more display elements includes microelectromechanical systems (MEMS) display elements.

12. The device of claim 1, wherein each of the primary seal and the secondary seal includes an epoxy-based adhesive.

13. The device of claim 1, further comprising:
one or more electrically conductive traces on the device substrate in the dummy area.

14. The device of claim 1, wherein the cover substrate includes glass.

15. The device of claim 1, further comprising:
a processor that is configured to communicate with the one or more display elements, the processor being configured to process image data; and
a memory device that is configured to communicate with the processor.

16. The device of claim 15, further comprising:
a driver circuit configured to send at least one signal to the one or more display elements; and
a controller configured to send at least a portion of the image data to the driver circuit.

17. The device of claim 15, further comprising:
an image source module configured to send the image data to the processor, wherein the image source module comprises at least one of a receiver, transceiver, and transmitter.

18. The device of claim 15, further comprising:
an input device configured to receive input data and to communicate the input data to the processor.

19. A display device comprising:
a device substrate;
means for displaying an image in the display device disposed on the device substrate;
a cover substrate opposite the device substrate;
first means for sealing the display device provided between the device substrate and the cover substrate, the first sealing means enclosing displaying means in a device area of the display device; and
second means for sealing the display device provided between the device substrate and the cover substrate, the second sealing means and the first sealing means defining a dummy area outside of the device area of the display device, wherein the cover substrate includes a device cavity extending partially through the cover substrate in the device area, and a dummy cavity extending partially through the cover substrate in the dummy area.

20. The device of claim 19, wherein a pressure inside the dummy area and the device area is less than about 1 atmosphere.

21. The device of claim 19, wherein a depth of the device cavity is between about 100 μm and about 400 μm, and a depth of the dummy cavity is between about 100 μm and about 400 μm.

22. The device of claim 19, wherein the display device is laminated.

23. A method of manufacturing a display device, the method comprising:
providing a device substrate with one or more display elements formed thereon;
providing a cover substrate opposite the device substrate;
forming a first seal around at least one of the display elements, the first seal between the device substrate and the cover substrate, the first seal enclosing a device area of the display device; and
forming a second seal around a dummy area outside of the device area and defined between the second seal and the first seal, the second seal between the device substrate and the cover substrate, wherein the cover substrate includes a device cavity extending partially through the cover substrate in the device area, and a dummy cavity extending partially through the cover substrate in the dummy area.

24. The method of claim 23, further comprising:
etching the cover substrate before providing the cover substrate opposite the device substrate to form the device cavity and the dummy cavity simultaneously in the cover substrate.

25. The method of claim 23, further comprising:
laminating the display device to reduce a size of a gap between the device substrate and the cover substrate.

26. The method of claim 25, wherein a pressure inside the device area and inside the dummy area is less than about 1 atmosphere after laminating the display device.

27. The method of claim 25, wherein a pressure inside the dummy area and a pressure inside the device area is substantially similar after laminating the display device.

28. The method of claim 23, wherein a depth of the device cavity is between about 100 μm and about 400 μm, and a depth of the dummy cavity is between about 100 μm and about 400 μm.
